(19) United States
(12) Patent Application Publication
(10) Pub. No.: US 2002/0123021 A1
(43) Pub. Date: Sep. 5, 2002

(54) Dental handpiece components

(75) Inventors: Tom Papanek, Lake Forest, IL (US); Lu He, Woodridge, IL (US); Amit J. Patel, Algonquin, IL (US)

Correspondence Address: Douglas J. Hura, DENTSPLY INTERNATIONAL INC., 570 West College Avenue, York, PA, 17405-0872, US

(73) Assignee: DENTSPLY Research & Development Corp.

(21) Appl. No.: 10/105,994

(22) Filed: Mar. 25, 2002

Related U.S. Application Data
(63) Continuation of application No. 10/082,762, filed on Feb. 25, 2002.
(60) Provisional application No. 60/256,580, filed on Dec. 18, 2000.

(51) Int. Cl. A61C 1/05

(52) U.S. Cl. 433/132; 433/131; 415/904

(57) ABSTRACT

A dental handpiece (10) of the type having at least one component (11) fabricated from an elastomeric material, is improved by fabricating the component (11) from a perfluoroelastomer.

### RELATED APPLICATIONS

This application is an ordinary application claiming the benefit from Provisional Application No. 60/256,580.

### TECHNICAL FIELD

The present invention is generally directed toward dental handpieces having components such as suspension rings, valves or seals made of an elastomeric material. More particularly, the invention is directed toward dental handpieces, of the type having for example, a rotor set including an air-driven rotor and upper and lower bearing assemblies, wherein the set is suspended axially or radially in the handpiece by means of suspension rings. Specifically, the present invention relates to the fabrication of handpiece components such as suspension rings, seals or valves from a perfluoroelastomer that resists degradation even after repeated sterilization. The invention also has application to other handpiece components, such as motors (air or electric), handpiece attachments and the like.

### BACKGROUND OF THE INVENTION

In dental handpieces today, many components such as the bearing suspension, seals and valves are made from elastomeric materials. For example, the bearing suspension is typically an elastomeric ring between bearing outer race and handpiece structure, which supports and isolates the bearings. An example of such a bearing ring is shown in U.S. Pat. No. 4,341,520 which is hereby incorporated by reference for its disclosure of such a ring and the general structure and function of a dental handpiece.

The stiffness of the suspension plays a role in handpiece “feel” during cutting, audible noise, and bearing life. Currently, the suspension rings in known handpieces are made of various grades of Viton or Kel-F rubbers, and these materials degrade after 300-800 sterilization cycles. It is believed that this degradation is a key determinant of handpiece life (before bearing replacement is required). Degradation can take various forms, including: (1) compression set, such that the suspension no longer provides the design bearing pre-load, which increases noise and leads to bearing failure; (2) changes in stiffness, which alters the dynamic response and “feel” of the handpiece during cutting; and, (3) catastrophic failure of the elastomer, leading rapidly to bearing failure. Such degradation is often exacerbated by repeated use and repeated exposure to conventional sterilization practices, which will often include exposure to high temperatures and pressures.

A need exists for elastomeric handpiece components that will withstand repeated sterilizations with increased resistance to such degradation. It has been found that components such as suspension rings, seals and valves made of perfluoroelastomers, such as Chemraz available from Green-Tweed, show demonstrably less of each degradation phenomena after repeated sterilization and therefore, results in longer usable life of the handpiece.

Use of Chemraz and other perfluoroelastomers is well known in sealing applications requiring high resistance to chemical attack and/or heat (e.g. semiconductor processing equipment). It is believed that there is no known prior art for a dental handpiece utilizing these materials for bearing suspension or any other purpose. There is no known prior art utilizing perfluoroelastomer elastomers as a bearing suspension material in non-dental applications, although it is known for use as an o-ring material, as is disclosed in U.S. Pat. No. 6,197,121.

The present invention has particular application to dental handpiece components, such as the suspension rings thereof. The invention also has application to other components, such as seals, valves, attachments to the handpiece and the like. The invention also has application to component parts of the handpiece motors which are made of an elastomeric material. By “motor” it is understood to mean any otherwise conventional motor, including air driven and electric motors. The present invention will be exemplified herein with reference to a dental handpiece, it being understood that by terms such as “handpiece” or “dental handpiece” that all such handpiece components, motors, attachments, valves, seals, rings or the like are included.

### SUMMARY OF THE INVENTION

It is therefore, an object of the present invention to provide an improved dental handpiece.

It is another object of the invention to provide an improved dental handpiece which is improved in regard to its ability to withstand repeated sterilization cycles.

These and other objects of the invention, which will be apparent from the present discussion, are accomplished by the invention as herein described and claimed.

In general, a dental handpiece of the type having at least one component fabricated from an elastomeric material is improved by fabricating the component from a perfluoroelastomer.

### BRIEF DESCRIPTION OF THE DRAWING AND TABLES

FIG. 1 shows a cross section of a dental handpiece head.

TABLE I shows the performance in terms of compression set of suspension materials subjected to repeated sterilization cycles. The conventional suspension materials (Viton-B and Kel-F) show up to five times the amount of compression set as the perfluoroelastomer (Chemraz) at 1800 equivalent sterilization cycles.

TABLE II shows the associated stiffness change occurring in the suspension material over 1800 sterilization cycles. The conventional suspension material stiffens by 137% and 81%, while the perfluoroelastomer stiffens by only 12%.

### DESCRIPTION OF THE PREFERRED EMBODIMENT

The present invention has application to dental handpiece components that are conventionally fabricated from an elastomeric material, such as is disclosed in the '520 patent. While the present invention will be exemplified herein by reference to a bearing suspension, it will be appreciated that the scope of the invention includes any dental handpiece component that is conventionally fabricated from an elastomeric material, including for example, seals and valves.

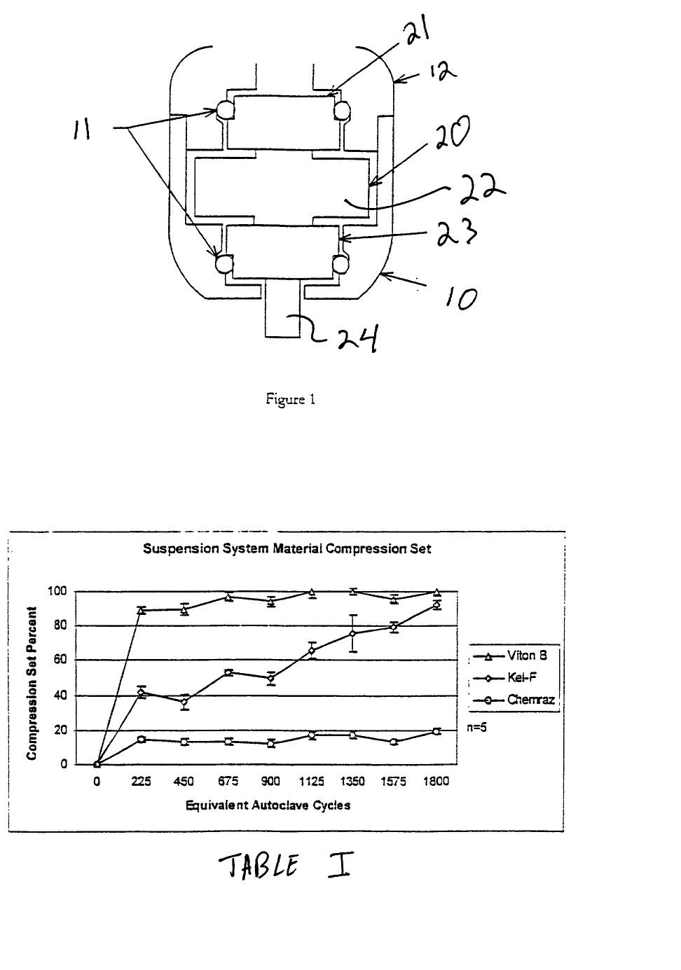

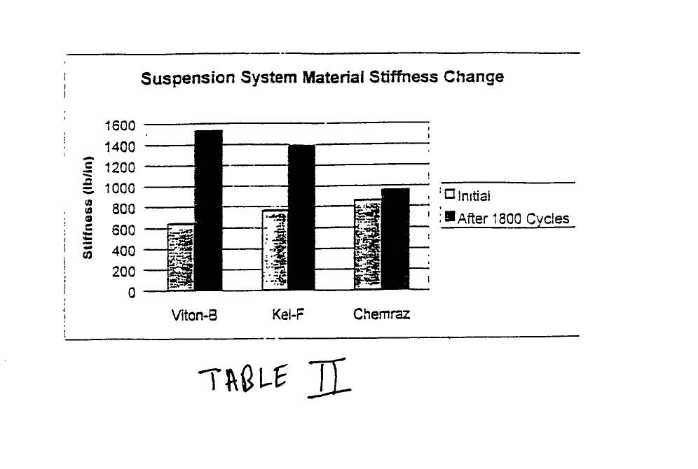

The head 10 of a conventional dental handpiece is shown in FIG. 1. Head 10 may be of any configuration, the only requirement being that it be of the type employing an elastomeric component, such as suspension rings 11. While the present invention has particular application to air-driven dental handpieces, any other type of handpiece driven by any conventional means is within the scope of the invention.

Handpiece head 10 includes a cap 12, and houses a rotor set generally designated by the number 20. Rotor set 20 includes an upper bearing 21, a rotor 22, and a lower bearing 23 with possible other components as is conventional in the dental handpiece art, such as rotatable shaft 24. Rotor set 20 is suspended axially (as shown) and/or radially in the head 10 by means of suspension rings 11.

Handpiece head 10 utilizes suspension o-rings 11 made of a perfluoroelastomer such as Chemraz available from Green-Tweed Inc. In particular, it has been found that Chemraz composition number CZ605 provides improved resistance to steam sterilization. However, other perfluoroelastomer such as International Seal compound PF128-75 and Forsheda Palmer-Chenard compound ISO9503 also provide performance better than currently used elastomers.

When used to fabricate an elastomeric dental handpiece component, such as a suspension ring 11, it has been found that the use of a perfluoroelastomer such as Chemraz CZ605 provides improved resistance to degradation as compared to conventional materials such as Viton B and Kel-F. As shown in TABLE I, the compression set of both Viton B and Kel-F were found to be substantially higher than that of Chemraz, as was the stiffness after repeated sterilization cycles as is reported in TABLE II.

An elastomeric dental handpiece component, including a suspension ring 11, seal or valve (not shown) fabricated from a perfluoroelastomer according to the invention, will therefore, exhibit increased resistance to degradation even after being exposed to repeated sterilization cycles as are conventionally used in dental practices. The present invention therefore provides a useful and unexpected contribution to the art of dental handpieces.

Any geometry of elastomeric component is within the scope of the invention. For example, other geometric forms of elastomeric suspension rings 11 include quad-rings, separate radial and axial rings, multiple rings, and the like (not shown) all of which are within the scope of the invention. Also, elastomeric components such as suspension rings 11 in conjunction with metallic springs (not shown) for axial bearing pre-load may be employed. Various geometry's of the bearing outer race and head cavity which form the boundaries of the suspension, and various formulations of perfluoroelastomeric material itself may all be varied and still fall within the scope of the invention. All such components fall within the scope of the term “suspension ring” and “elastomeric component” as used herein.

It is evident therefore, that the objects of a dental handpiece are carried out by the invention as herein described. All possible aspects of the invention beyond the best mode have not been necessarily described, and the scope of the invention shall only be determined by the following claims.

What is claimed is:

1. A dental handpiece of the type having at least one elastomeric component, the improvement comprising fabricating the elastomeric component from a perfluoroelastomer.

2. A dental handpiece as in claim 1, wherein the elastomeric component is a suspension ring.

3. A method of making a dental handpiece comprising the step of fabricating at least one component of the handpiece from a perfluoroelastomer.

4. A method as in claim 3, wherein said step of fabricating at least one component includes fabricating a bearing suspension ring.

5. A dental handpiece formed according to the method of claim 3.

6. A dental handpiece comprising:
a head, a rotor set and a rotatable shaft within said head, said rotor set having at least one bearing, wherein said rotor set is suspended within said head with a suspension ring fabricated from a perfluoroelastomer.
